(19) United States
(12) Patent Application Publication
(10) Pub. No.: US 2018/0222475 A1
(43) Pub. Date: Aug. 9, 2018

(54) METHOD, CONTROL UNIT AND SYSTEM FOR PATH PREDICTION IN A VEHICLE

(71) Applicant: Scania CV AB, Södertälje (SE)

(72) Inventors: Jonny ANDERSSON, Södertälje (SE); Marie BEMLER, Mariefred (SE); Joseph AH-KING, Södertälje (SE); Christian LARSSON, Stockholm (SE)

(21) Appl. No.: 15/750,153

(22) PCT Filed: Aug. 16, 2016
(86) PCT No.: PCT/SE2016/050760

§ 371 Date: Feb. 2, 2018

(30) Foreign Application Priority Data
Aug. 20, 2015 (SE) 1551085-2

(51) Int. Cl. B60W 30/095; B60W 40/114; B60W 50/00; G08G 1/16

(52) U.S. Cl. CPC B60W 30/095; B60W 40/114; B60W 50/0097; G08G 1/166; B60W 2050/002; B60W 2050/006; B60W 2710/207; B60W 2540/20; B60W 2540/18; B60W 2550/14; B60W 2520/10; B60W 2550/406; B60W 2720/14; B60W 2420/42

(57) ABSTRACT

Method and control unit for predicting a path of a vehicle are provided. The method comprises measuring velocity of the vehicle; measuring steering wheel angle (α_{sw}); measuring steering wheel angle rate (α′_{sw}); calculating a future steering wheel angle (α_{sw}), based on the measured steering wheel angle (α_{sw}) and the measured steering wheel angle rate (α′_{sw}); calculating a future yaw rate (ω) of the vehicle based on the measured velocity of the vehicle and the calculated future steering wheel angle (α_{sw}); extrapolating a vehicle position of the vehicle in a set of future time frames, based on the calculated future yaw rate (ω) and the vehicle velocity; and predicting the path of the vehicle based on the extrapolated vehicle positions in the set of future time frames.

### CROSS-REFERENCE TO RELATED APPLICATION(S)

This application is a national stage application (filed under 35 § U.S.C. 371) of PCT/SE2016/050760, filed Aug. 16, 2016 of the same title, which, in turn claims priority to Swedish Application No. 1551085-2, filed Aug. 20, 2015 of the same title; the contents of each of which are hereby incorporated by reference.

### FIELD OF THE INVENTION

The invention relates to a method, a control unit and a system in a vehicle. More particularly, a method, a control unit and a system is described for predicting a path of the vehicle.

### BACKGROUND OF THE INVENTION

Non-motorized road users, such as e.g. pedestrians and cyclists as well as motorcyclists and persons with disabilities and/ or reduced mobility and orientation are sometimes referred to as Vulnerable Road Users (VRU). This heterogeneous group is disproportionately represented in statistics on injuries and road traffic casualties.

A particularly dangerous scenario is when VRUs are situated in the vehicle driver's blind spot when the vehicle is turning at low speeds.

In addition, pedestrians sometimes try crossing the street on a road sequence without being aware of the problems for the driver to see the pedestrian, assuming that the vehicle driver will let the pedestrian pass (which assumption may become lethal in case the driver does not see the pedestrian).

Another similar problem may appear when driving in city traffic when a bicycle is approaching a vehicle from behind on the inside, while the vehicle is turning right. The bicyclist may then not be able to see the turning indicators of the vehicle, while the vehicle driver may not be able to see the bicyclist, which may result in a serious accident.

The above described scenarios may be in particular severe when the vehicle is a large, sight blocking vehicle such as e.g. a bus, a truck or similar, but also a private car may block the sight of an undersized pedestrian, such as e.g. a child, a wheelchair user or a pet.

No advanced warning systems for VRUs in a vehicle's blind zone is yet known. Simple systems exist on the market today, which are based on ultrasonic sensors which identify the presence of “anything” next to the vehicle when turning or when using turn indicators. US 2013253815 relates to a system of determining information about a path or a road vehicle. At least two possible reference paths for the vehicle are determined, and determining information relating to an intermediate path lying between the reference paths.

Predicting when a driver/vehicle is about to take a sharp turn before it happens is extremely difficult but essential for building a reliable VRU warning function in a vehicle. A path prediction that is too restrictive will most likely ignore or delay warnings in some dangerous situations, while a too generous path prediction is most likely to give lots of “false” warnings as soon as someone is walking near the vehicle, such as e.g. on the sidewalk separated from the road.

Thus it would be desired to discover a method for predicting a vehicle turn, which may be used e.g. in a VRU warning system.

### SUMMARY OF THE INVENTION

It is therefore an object of this invention to solve at least some of the above problems and improve the traffic security.

According to a first aspect of the invention, this objective is achieved by a method for predicting a path of a vehicle. The method comprises predicting a path of a vehicle as a part of a Vulnerable Road User warning system, comprising: measuring velocity of the vehicle; measuring steering wheel angle (α_{sw}), measuring. steering wheel angle rate (α′_{sw}). The method further comprises calculating a future steering wheel angle (α_{sw}), based on the measured steering wheel angle (α_{sw}) and the measured steering wheel angle rate (α′_{sw}), wherein the steering wheel acceleration (α_{sw}″) is constant during the set of future time frames and set based on the measured velocity of the vehicle, and turn indicator status; The method also comprises calculating a future yaw rate (ω) of the vehicle based on the measured velocity of the vehicle and the calculated future steering wheel angle (α_{sw}); extrapolating a vehicle position of the vehicle in a set of future time frames, based on the calculated future yaw rate (ω) and the vehicle velocity; and predicting the path of the vehicle based on the extrapolated vehicle positions in the set of future time frames, further based on road border detection made by a camera in the vehicle.

According to a second aspect of the invention, this objective is achieved by a control unit in a vehicle. The control unit is configured for predicting a path of the vehicle in accordance with the above.

According to a third aspect of the invention, this objective is achieved by a computer program comprising program code for performing a method according to the first aspect when the computer program is executed in a control unit according to the second aspect.

According to a fourth aspect, this objective is achieved by a system for predicting a path of the vehicle. The system comprises a control unit according to the second aspect. The system furthermore comprises a sensor for measuring steering wheel angle and steering wheel angle rate of the steering wheel of the vehicle.

Thanks to the described aspects, the path of the vehicle is predicted by determining the steering wheel angle and steering wheel angle rate of the steering wheel of the vehicle, in addition to the vehicle velocity, using an equation expressing the relation between the steering wheel angle and the yaw rate of the vehicle. An accurate path prediction is essential e.g. for creating a reliable VRU warning system that warns/intervenes when a collision with a VRU is really probable, i.e. when the predicted path of the vehicle and a predicted path for the VRU are overlapping. Such system will gain high acceptance and trust as superfluous warnings are eliminated or at least reduced, which in turn is expected to reduce fatalities of turn accidents. Thus increased traffic security is achieved.

Also activation of the turn indicator is considered as an important factor for determining that the vehicle is going to turn in the indicated direction. It may thereby be distinguished between a brief avoidance manoeuvre made by the driver to avoid e.g. an object on the road, a hole in the driveway or similar; and an initiation of a turn. By reducing false warnings, the system will gain high acceptance and trust as superfluous warnings are eliminated or at least reduced, which in turn is expected to reduce fatalities of turn accidents. Thus increased traffic security is achieved.

Further, the camera is enabled to detect the road surface or natural borders of the road, such as elevated sidewalks etc. Thereby the path prediction may be improved, for example by limiting the path by assuming that the own vehicle stays on the road; and/or by lowering or limiting the value for α″_{sw} when the vehicle is close to the road border. Thereby the number of false warnings for VRUs, such as pedestrians/bicyclists that reside close to the own vehicle but on an elevated sidewalk is minimized, or at least reduced.

Other advantages and additional novel features will become apparent from the subsequent detailed description.

### BRIEF DESCRIPTION OF THE DRAWINGS

Embodiments of the invention will now be described in further detail with reference to the accompanying figures, in which:

FIG. 1 illustrates a vehicle according to an embodiment of the invention;

FIG. 2 illustrates an example of a traffic scenario and an embodiment of the invention;

FIG. 3 illustrates an example of a vehicle interior according to an embodiment;

FIG. 4 is a flow chart illustrating an embodiment of the method; and

FIG. 5 is an illustration depicting a system according to an embodiment.

### DETAILED DESCRIPTION OF THE INVENTION

Embodiments of the invention described herein are defined as a method, a control unit and a system, which may be put into practice in the embodiments described below. These embodiments may, however, be exemplified and realized in many different forms and are not to be limited to the examples set forth herein; rather, these illustrative examples of embodiments are provided so that this disclosure will be thorough and complete.

Still other objects and features may become apparent from the following detailed description, considered in conjunction with the accompanying drawings. It is to be understood, however, that the drawings are designed solely for purposes of illustration and not as a definition of the limits of the herein disclosed embodiments, for which reference is to be made to the appended claims. Further, the drawings are not necessarily drawn to scale and, unless otherwise indicated, they are merely intended to conceptually illustrate the structures and procedures described herein.

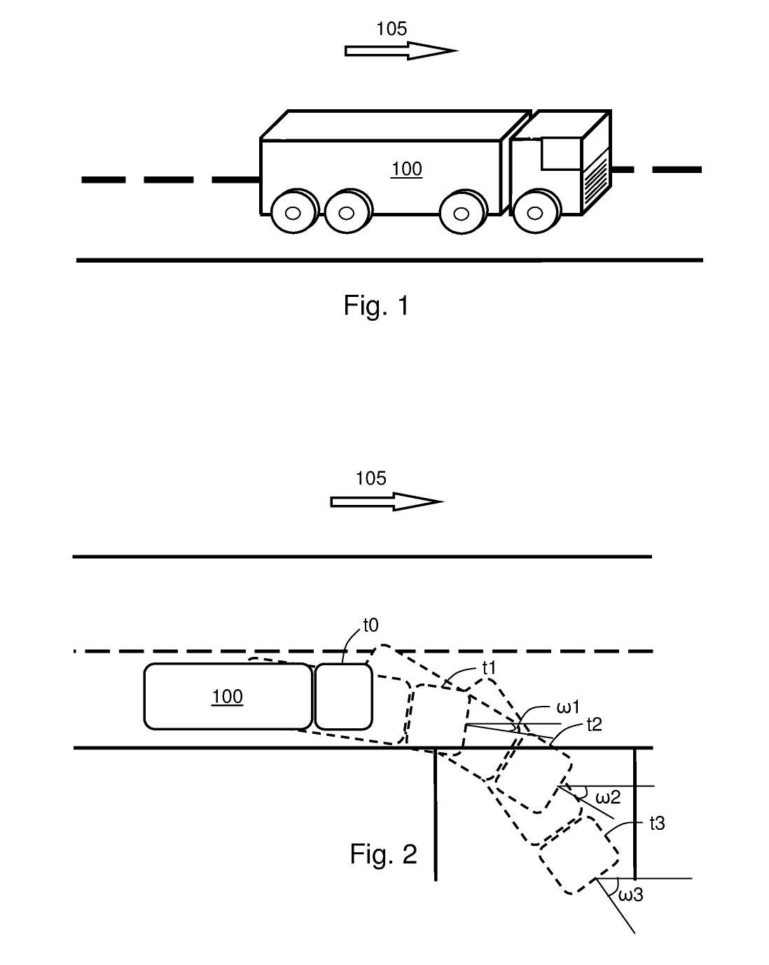

FIG. 1 illustrates a scenario with a vehicle 100. The vehicle 100 is driving on a road in a driving direction 105.

The vehicle 100 may comprise e.g. a truck, a bus or a car, or any similar vehicle or other means of conveyance.

Further, the herein described vehicle 100 may be driver controlled or driverless, autonomously controlled vehicles 100 in some embodiments. However, for enhanced clarity, they are subsequently described as having a driver.

FIG. 2 schematically illustrates a scenario, similar to the previously discussed scenario illustrated in FIG. 1, but seen from an above perspective and wherein a predicted future path of the vehicle 100 is depicted.

A possible path of the vehicle 100 is predicted by using available information. The path prediction comprises determining steering wheel angle and steering wheel rate, and possibly also determining if direction indicators are activated. Further, in some embodiments, the path prediction may also use a camera system that can detect the road surface or natural borders of the road such as elevated sidewalks etc., to improve the path prediction. If high-resolution map data is available, similar effects can be gained by increasing the probability of a turn near an intersection.

The prediction is based on formula [1] for calculating the steady-state relationship between steering wheel angle and yaw rate of the vehicle 100:

α_{sw}*v=n*(L+Kᵤₛ*v²)*ω [1]

where ω=yaw rate (rad/s); α_{sw}=steering wheel angle (rad); v=vehicle speed; L=effective wheel base (distance from front axle to effective rotation centre); and Kᵤₛ=understeer gradient (s²/m).

At low speeds (which are normally relevant for VRU warning systems), the term Kᵤₛ*v² may be neglected for simplification, leading to:

α_{sw}*v=n*L*ω. [2]

Assuming that α_{sw}, \dot{α}_{sw} (steering angle rate) and direction indicator signals can be measured, the possible path can be calculated as:

α_{sw}(t)=α_{sw}(0)+∫₀^{t}\dot{α}_{sw}(t)dt=α_{sw}(0)+∫∫₀^{t}\ddot{α}_{sw}dt, [3]

where the steering wheel acceleration, \ddot{α}_{sw}, is assumed to be constant during the turn. The specific value of \ddot{α}_{sw} may be set depending on ego vehicle speed and/or if the turn indicator (for this side) is on according to some embodiments.

Using equations (2) and (3), the yaw rate ω for each relevant time step is calculated. Certain limits on steering wheel angle and/or steering wheel rate can also be applied to limit the path prediction when the driver quickly steers to one side. For example, for some vehicle types it might be reasonable to assume that a turn is never more than 90 degrees within a given time frame. For other vehicles, such as a truck with trailer, it might be necessary to steer more to negotiate certain turns. Furthermore, buses with large overhang takes wide curves to negotiate turns, which may also be taken into account in the predictions in some embodiments.

In some embodiments, the vehicle 100 comprises a camera system. The camera system may be able to detect the road surface or natural borders of the road, such as elevated sidewalks etc. Thereby the path prediction may be improved, for example by limiting the path by assuming that the own vehicle 100 stays on the road, or by lowering or limiting the value for \ddot{α}_{sw} when the vehicle 100 is close to the road border. Thereby the number of false warnings for VRUs, such as pedestrians/bicyclists that reside close to the own vehicle 100 but on an elevated sidewalk.

In the illustrated arbitrary example, the vehicle 100 is driving straight forward on the road in a first time frame t0, i.e. the yaw rate ω is zero. By measuring the velocity v of the vehicle 100, the steering wheel angle α_{sw} and the steering angle rate \dot{α}_{sw}, , and by using equations (2) and (3), the yaw rate ω1 for each time frame t1 is calculated. By iterating the calculations of equations (2) and (3), based on the predicted position in time frame t1, the yaw rates ω2, ω3 and vehicle positions in time frames t2 and t3 may be predicted. It may thereby be predicted that the vehicle 100 is turning to the right, in this example.

An accurate path prediction is the backbone for creating a reliable VRU warning system that only warns/intervenes when a collision with a VRU is really probable and impending. Such system will gain higher acceptance and trust which in turn is expected to reduce fatalities of turn accidents.

However, the disclosed method for path prediction of the vehicle 100 is not limited to VRU warning systems, but may be used for various other purposes.

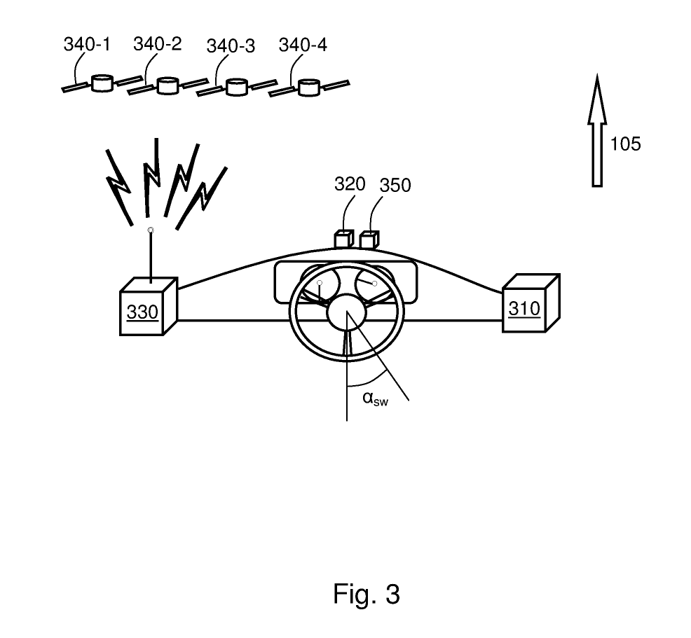

FIG. 3 illustrates an example of a vehicle interior of the vehicle 100 and depicts how the previously scenario in FIG. 1 and/or FIG. 2 may be perceived by the driver of the vehicle 100.

The vehicle 100 comprises a control unit 310. The control unit 310 is able to obtain measurements required to perform the calculations according to equations (2) and (3). Further the vehicle 100 also comprises sensor 320 for measuring steering wheel angle α_{sw} and steering wheel angle rate α′_{sw} of the steering wheel of the vehicle 100. In some embodiments, two or more sensors 320 may be utilized, such as e.g. one sensor 320 for measuring the steering wheel angle α_{sw} and a separate sensor 320 for measuring the steering wheel angle rate α′_{sw}.

The velocity of the vehicle 100 may be measured or estimated by the speedometer in the vehicle, or by the positioning device 330.

The geographical position of the vehicle 100 may be determined by a positioning device 330, or navigator, in the vehicle 100, which may be based on a satellite navigation system such as the Navigation Signal Timing and Ranging (Naystar) Global Positioning System (GPS), Differential GPS (DGPS), Galileo, GLONASS, or the like.

The geographical position of the positioning device 330, (and thereby also of the vehicle 100) may be made continuously with a certain predetermined or configurable time intervals according to various embodiments.

Positioning by satellite navigation is based on distance measurement using triangulation from a number of satellites 340-1, 340-2, 340-3, 340-4. In this example, four satellites 340-1, 340-2, 340-3, 340-4 are depicted, but this is merely an example. More than four satellites 340-1, 340-2, 340-3, 340-4 may be used for enhancing the precision, or for creating redundancy. The satellites 340-1, 340-2, 340-3, 340-4 continuously transmit information about time and date (for example, in coded form), identity (which satellite 340-1, 340-2, 340-3, 340-4 that broadcasts), status, and where the satellite 340-1, 340-2, 340-3, 340-4 are situated at any given time. The GPS satellites 340-1, 340-2, 340-3, 340-4 sends information encoded with different codes, for example, but not necessarily based on Code Division Multiple Access (CDMA). This allows information from an individual satellite 340-1, 340-2, 340-3, 340-4 distinguished from the others' information, based on a unique code for each respective satellite 340-1, 340-2, 340-3, 340-4. This information can then be transmitted to be received by the appropriately adapted positioning device comprised in the vehicles 100.

Distance measurement can according to some embodiments comprise measuring the difference in the time it takes for each respective satellite signal transmitted by the respective satellites 340-1, 340-2, 340-3, 340-4 to reach the positioning device 330. As the radio signals travel at the speed of light, the distance to the respective satellite 340-1, 340-2, 340-3, 340-4 may be computed by measuring the signal propagation time.

The positions of the satellites 340-1, 340-2, 340-3, 340-4 are known, as they continuously are monitored by approximately 15-30 ground stations located mainly along and near the earth's equator. Thereby the geographical position, i.e. latitude and longitude, of the vehicle 100 may be calculated by determining the distance to at least three satellites 340-1, 340-2, 340-3, 340-4 through triangulation. For determination of altitude, signals from four satellites 340-1, 340-2, 340-3, 340-4 may be used according to some embodiments.

Having determined the geographical position of the vehicle 100 by the positioning device 330 (or in another way), it may be presented on a map, a screen or a display device where the position of the vehicle 100 may be marked in some optional, alternative embodiments.

In some embodiments, the current geographical position of the vehicle 100 and the computed predicted path of the vehicle 100 may in some embodiments be displayed on an interface unit. The interface unit may comprise a mobile telephone, a computer, a computer tablet or any similar device.

Furthermore, the vehicle 100 may comprise a camera 350 in some embodiments. The camera 350 may be situated e.g. at the front of the vehicle 100, behind the windscreen of the vehicle 100. An advantage by placing the camera 350 behind the windscreen is that the camera 350 is protected from dirt, snow, rain and to some extent also from damage, vandalism and/or theft.

The camera 350 may comprise e.g. a camera, a stereo camera, an infrared camera, a video camera, a thermal camera or a time-of-flight camera in different embodiments.

The camera 350 may be directed towards the front of the vehicle 100, in the driving direction 105. Thereby, the camera 350 may detect road limitations ahead of the vehicle 100, such as an elevated sidewalk, and/or a crossroad or road junction.

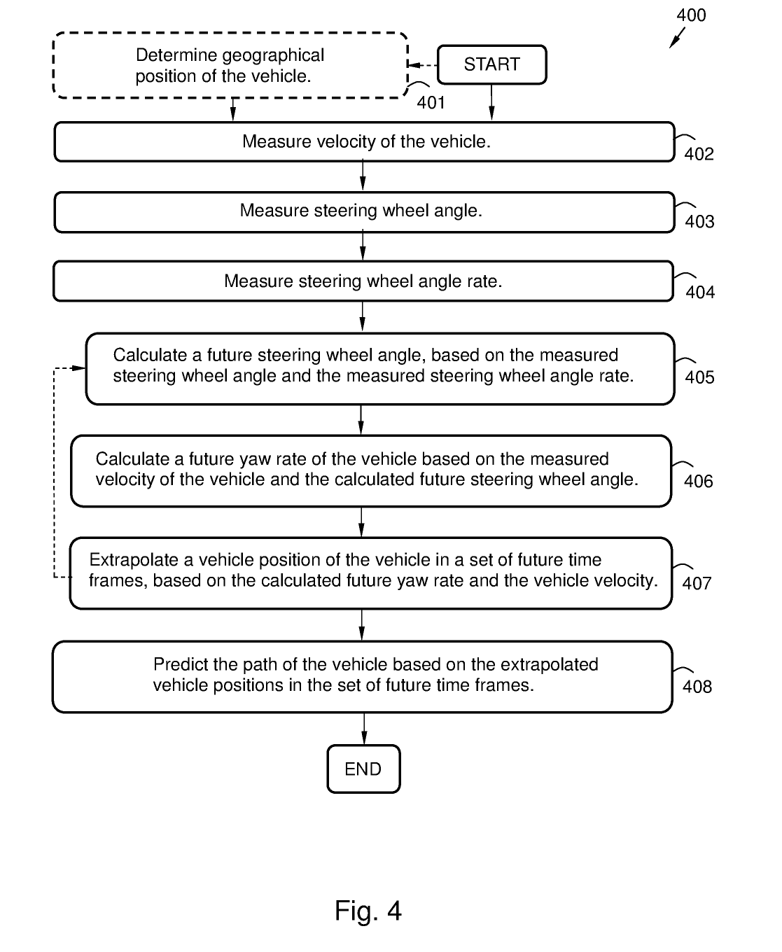

FIG. 4 illustrates an example of a method 400 according to an embodiment. The flow chart in FIG. 4 shows the method 400 for use in a vehicle 100. The method 400 aims at predicting a path of the vehicle 100.

The vehicle 100 may be e.g. a truck, a bus, a car, a motorcycle or similar.

In order to correctly be able to predict the path of the vehicle 100, the method 400 may comprise a number of steps 401-408. However, some of these steps 401-408 may be performed solely in some alternative embodiments, like e.g. step 401. Further, the described steps 401-408 may be performed in a somewhat different chronological order than the numbering suggests. The method 400 may comprise the subsequent steps:

Step 401 which may be performed only in some particular embodiments, comprises determining geographical position of the vehicle 100.

The current vehicle position may be determined by a geographical positioning device 330, such as e.g. a GPS. However, the current position of the vehicle 100 may alternatively be detected and registered by the driver of the vehicle 100 in some embodiments. In some further embodiments, the geographical position may be detected by a sensor and be relative to a previously determined position.

Step 402 comprises measuring velocity of the vehicle 100.

The velocity may be measured by the speedometer of the vehicle 100, or by the positioning device 330, in different embodiments.

Step 403 comprises measuring steering wheel angle α_{sw}. The steering wheel angle α_{sw} may be measured by a sensor 320.

Step 404 comprises measuring steering wheel angle rate α′_{sw}. The steering wheel angle rate α′_{sw} may be measured by a sensor 320.

Step 405 comprises calculating a future steering wheel angle α_{sw}, based on the measured 403 steering wheel angle α_{sw}and the measured 404 steering wheel angle rate α′_{sw}.

The calculation of the future steering wheel angle α_{sw} at a time t may in some embodiments be made by:

α_{sw}(t)=α_{sw}(0)+∫₀^{t}\dot{α}_{sw}(t)dt=α_{sw}(0)+∫∫₀^{t}\ddot{α}_{sw}dt

Step 406 comprises calculating a future yaw rate ω of the vehicle 100 based on the measured 402 velocity of the vehicle 100 and the calculated future steering wheel angle α_{sw}.

Step 407 comprises extrapolating a vehicle position of the vehicle 100 in a set of future time frames, based on the calculated 406 future yaw rate ω and the vehicle velocity.

The extrapolated vehicle position of the vehicle 100 may comprise iteration of the steps of calculating 405 the future steering wheel angle α_{sw} and calculating 406 a future yaw rate ω of the vehicle 100, in some embodiments.

According to some embodiments, the steering wheel acceleration α_{sw}″ may be constant during the set of future time frames and set based on measured 402 velocity of the vehicle 100, and turn indicator status.

Step 408 comprises predicting the path of the vehicle 100 based on the extrapolated 407 vehicle positions in the set of future time frames.

The prediction of the vehicle path may be further based on road border detection made by a camera 350 in the vehicle 100. The camera 350 may comprise e.g. a camera, a stereo camera, an infrared camera, a video camera, or a time-of-flight camera.

Furthermore, in some embodiments, the prediction of the vehicle path may be further based on map data at the determined 401 geographical position of the vehicle 100.

The prediction of the vehicle path is further based on a destination of the vehicle 100, extracted from a navigator 330 of the vehicle 100.

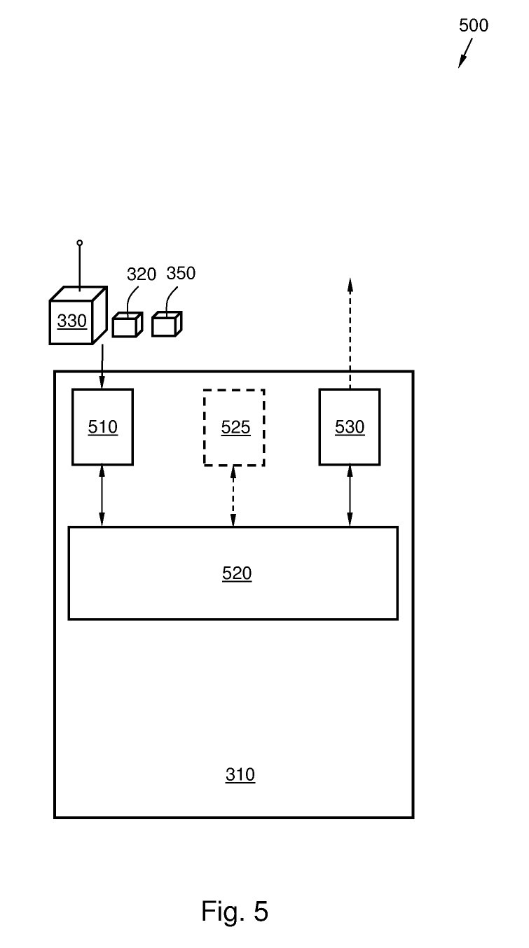

FIG. 5 illustrates an embodiment of a system 500 for predicting a path of a vehicle 100. The system 500 may perform at least some of the previously described steps 401-408 according to the method 400 described above and illustrated in FIG. 4.

The system 500 comprises a control unit 310 in the vehicle 100. The control unit 310 is arranged for performing calculations for predicting the path of the vehicle 100. The control unit 310 may in some alternative embodiments be configured for determining geographical position of the vehicle 100, e.g. via a positioning device 330 such as a GPS, or via relative sensor measurements. Further the control unit 310 is configured for measuring velocity of the vehicle 100. In addition the control unit 310 is further configured for measuring steering wheel angle α_{sw}. The control unit 310 is also configured for measuring steering wheel angle rate α′_{sw}. In further addition, the control unit 310 is configured for calculating a future steering wheel angle α_{sw}, based on the measured steering wheel angle α_{sw} and the measured steering wheel angle rate α′_{sw}. Furthermore the control unit 310 is additionally configured for calculating a future yaw rate ω of the vehicle 100 based on the measured velocity of the vehicle 100 and the calculated future steering wheel angle α_{sw}. The control unit 310 is further configured for extrapolating a vehicle position of the vehicle 100 in a set of future time frames, based on the calculated future yaw rate ω and the vehicle velocity, starting e.g. from a determined geographical position of the vehicle 100. The control unit 310 is also configured for predicting the path of the vehicle 100 based on the extrapolated vehicle positions in the set of future time frames.

The control unit 310 comprises a receiving circuit 510 configured for receiving a signal from the sensor 320, from the positioning device 330 and/or the camera 350.

Further, the control unit 310 comprises a processor 520 configured for performing at least some steps of the method 400, according to some embodiments.

Such processor 520 may comprise one or more instances of a processing circuit, i.e. a Central Processing Unit (CPU), a processing unit, a processing circuit, an Application Specific Integrated Circuit (ASIC), a microprocessor, or other processing logic that may interpret and execute instructions. The herein utilized expression “processor” may thus represent a processing circuitry comprising a plurality of processing circuits, such as, e.g., any, some or all of the ones enumerated above.

Furthermore, the control unit 310 may comprise a memory 525 in some embodiments. The optional memory 525 may comprise a physical device utilized to store data or programs, i.e., sequences of instructions, on a temporary or permanent basis. According to some embodiments, the memory 525 may comprise integrated circuits comprising silicon-based transistors. The memory 525 may comprise e.g. a memory card, a flash memory, a USB memory, a hard disc, or another similar volatile or non-volatile storage unit for storing data such as e.g. ROM (Read-Only Memory), PROM (Programmable Read-Only Memory), EPROM (Erasable PROM), EEPROM (Electrically Erasable PROM), etc. in different embodiments.

Further, the control unit 310 may comprise a signal transmitter 530. The signal transmitter 530 may be configured for transmitting a signal to e.g. a display device, or a VDU warning system or warning device, for example.

In addition the system 500 in some embodiments also may comprise a positioning device 330 for determining geographical position of the vehicle 100.

The system 500 further comprises a sensor 320 in the vehicle 100. The sensor 320 is configured for measuring steering wheel angle as, and steering wheel angle rate α′_{sw} of the steering wheel of the vehicle 100. The sensor 320 may comprise e.g. a camera, a stereo camera, an infrared camera, a video camera or similar.

The above described steps 401-408 to be performed in the vehicle 100 may be implemented through the one or more processors 520 within the control unit 310, together with computer program product for performing at least some of the functions of the steps 401-408. Thus a computer program product, comprising instructions for performing the steps 401-408 in the control unit 310 may perform the method 400 comprising at least some of the steps 401-408 for predicting a path of the vehicle 100, when the computer program is loaded into the one or more processors 520 of the control unit 310.

Further, some embodiments may comprise a vehicle 100, comprising the control unit 310, configured for predicting a path of a vehicle 100, according to at least some of the steps 401-408.

The computer program product mentioned above may be provided for instance in the form of a data carrier carrying computer program code for performing at least some of the steps 401-408 according to some embodiments when being loaded into the one or more processors 520 of the control unit 310. The data carrier may be, e.g., a hard disk, a CD ROM disc, a memory stick, an optical storage device, a magnetic storage device or any other appropriate medium such as a disk or tape that may hold machine readable data in a non-transitory manner. The computer program product may furthermore be provided as computer program code on a server and downloaded to the control unit 310 remotely, e.g., over an Internet or an intranet connection.

The terminology used in the description of the embodiments as illustrated in the accompanying drawings is not intended to be limiting of the described method 400; the control unit 310; the computer program; the system 500 and/or the vehicle 100. Various changes, substitutions and/or alterations may be made, without departing from invention embodiments as defined by the appended claims.

As used herein, the term “and/or” comprises any and all combinations of one or more of the associated listed items. The term “or” as used herein, is to be interpreted as a mathematical OR, i.e., as an inclusive disjunction; not as a mathematical exclusive OR (XOR), unless expressly stated otherwise. In addition, the singular forms “a”, “an” and “the” are to be interpreted as “at least one”, thus also possibly comprising a plurality of entities of the same kind, unless expressly stated otherwise. It will be further understood that the terms “includes”, “comprises”, “including” and/or “comprising”, specifies the presence of stated features, actions, integers, steps, operations, elements, and/or components, but do not preclude the presence or addition of one or more other features, actions, integers, steps, operations, elements, components, and/or groups thereof. A single unit such as e.g. a processor may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms such as via Internet or other wired or wireless communication system.

1. A method for predicting a path of a vehicle as a part of a Vulnerable Road User warning system, comprising:
measuring velocity of the vehicle;
measuring steering wheel angle (α_{sw});
measuring steering wheel angle rate (α′_{sw});
calculating a future steering wheel angle (α_{sw}), based on the measured steering wheel angle (α_{sw}) and the measured steering wheel angle rate (α′_{sw});
calculating a future yaw rate (ω) of the vehicle based on the measured velocity of the vehicle and the calculated future steering wheel angle (α_{sw});
extrapolating a vehicle position of the vehicle in a set of future time frames, based on the calculated future yaw rate (ω) and the vehicle velocity; and
predicting the path of the vehicle based on the extrapolated vehicle positions in the set of future time frames, further based on a road border detection made by a camera in the vehicle.

2. The method according to claim 1, wherein the extrapolated vehicle position of the vehicle comprises iteration of the steps of calculating the future steering wheel angle (α_{sw}) and calculating a future yaw rate (ω) of the vehicle.

3. The method according to claim 1, further comprising:
determining geographical position of the vehicle, and
wherein the prediction of the vehicle path is further based on map data at the determined geographical position of the vehicle.

4. The method according to claim 3, wherein the prediction of the vehicle path is further based on a destination of the vehicle, extracted from a navigator of the vehicle.

5. The method according to claim 1, wherein the calculation of the future steering wheel angle (α_{sw}) at a time (t) is made by:
α_{sw}(t)=α_{sw}(0)+∫₀^{t}\dot{α}_{sw}(t)dt=α_{sw}(0)+∫∫₀^{t}\ddot{α}_{sw}dt.

6. A control unit in a vehicle being a part of a Vulnerable Road User warning system, for predicting a path of the vehicle, wherein the control unit is configured for:
determining velocity of the vehicle;
determining steering wheel angle (α_{sw});
determining steering wheel angle rate (α′_{sw});
calculating a future steering wheel angle (α_{sw}), based on the determined steering wheel angle (α_{sw}) and the determined steering wheel angle rate (α′_{sw});
calculating a future yaw rate (ω) of the vehicle based on the determined measured velocity of the vehicle and the calculated future steering wheel angle (α_{sw});
extrapolating a vehicle position of the vehicle in a set of future time frames, based on the calculated future yaw rate (ω) and the vehicle velocity;
receiving a signal from a camera 450 representing a road border detection; and
predicting the path of the vehicle based on the extrapolated vehicle positions in the set of future time frames, further based on the road border detection made by the camera in the vehicle.

7. A computer program product comprising program code stored on a non-transitory computer-readable medium, said computer program product for predicting a path of a vehicle as a part of a Vulnerable Road User warning system, said computer program product comprising computer instructions to cause one or more computer processors to perform the following operations:
determining a velocity of the vehicle;
determining a steering wheel angle (α_{sw});
determining a steering wheel angle rate (α′_{sw});
calculating a future steering wheel angle (α_{sw}), based on the determined steering wheel angle (α_{sw}) and the determined steering wheel angle rate (α′_{sw});
calculating a future yaw rate (ω) of the vehicle based on the determined velocity of the vehicle and the calculated future steering wheel angle (α_{sw});
extrapolating a vehicle position of the vehicle in a set of future time frames, based on the calculated future yaw rate (ω) and the vehicle velocity; and
predicting the path of the vehicle based on the extrapolated vehicle positions in the set of future time frames, further based on a road border detection made by a camera in the vehicle.

8. A system for predicting a path of the vehicle, comprising:
a sensor for measuring a steering wheel angle (α_{sw}) and a steering wheel angle rate (α′_{sw}) of a steering wheel of the vehicle; and
a control unit configured for:
determining a velocity of the vehicle;
determining a steering wheel angle (α_{sw});
determining a steering wheel angle rate (α′_{sw});
calculating a future steering wheel angle (α_{sw}), based on the determined steering wheel angle (α_{sw}) and the determined steering wheel angle rate (α′_{sw});
calculating a future yaw rate (ω) of the vehicle based on the determined velocity of the vehicle and the calculated future steering wheel angle (α_{sw});
extrapolating a vehicle position of the vehicle in a set of future time frames, based on the calculated future yaw rate (ω) and the vehicle velocity;
receiving a signal from a camera representing a road border detection; and
predicting the path of the vehicle based on the extrapolated vehicle positions in the set of future time frames, further based on the road border detection made by the camera.

9. The method according to claim 1, wherein in said calculating a future steering wheel angle, a steering wheel acceleration (α_{sw}″) is constant during the set of future time frames and set based on the measured velocity of the vehicle, and a turn indicator status.

10. The control unit according to claim 6, wherein in said calculating a future steering wheel angle, a steering wheel acceleration (α_{sw}″) is constant during the set of future time frames and set based on the measured velocity of the vehicle, and a turn indicator status.

11. The control unit according to claim 6, wherein the extrapolated vehicle position of the vehicle comprises iteration of the steps of calculating the future steering wheel angle (α_{sw}) and calculating a future yaw rate (ω) of the vehicle.

12. The control unit according to claim 6 further configured for:
determining geographical position of the vehicle, and
wherein the prediction of the vehicle path is further based on map data at the determined geographical position of the vehicle.

13. The computer program product according to claim 7, wherein in said calculating a future steering wheel angle, a steering wheel acceleration (α_{sw}″) is constant during the set of future time frames and set based on the measured velocity of the vehicle, and a turn indicator status.

14. The computer program product according to claim 7, wherein the extrapolated vehicle position of the vehicle comprises iteration of the steps of calculating the future steering wheel angle (α_{sw}) and calculating a future yaw rate (ω) of the vehicle.

15. The computer program product according to claim 7 further configured for:
determining geographical position of the vehicle, and
wherein the prediction of the vehicle path is further based on map data at the determined geographical position of the vehicle.

16. The system according to claim 8, wherein in said calculating a future steering wheel angle, a steering wheel acceleration (αₛw“”) is constant during the set of future time frames and set based on the measured velocity of the vehicle, and a turn indicator status.

17. The system according to claim 8, wherein the extrapolated vehicle position of the vehicle comprises iteration of the steps of calculating the future steering wheel angle (α_{sw}) and calculating a future yaw rate (ω) of the vehicle.

18. The system according to claim 8, wherein the control unit is further configured for:
determining geographical position of the vehicle, and
wherein the prediction of the vehicle path is further based on map data at the determined geographical position of the vehicle.
